(19) United States
(12) Patent Application Publication
(10) Pub. No.: US 2025/0338291 A1
(43) Pub. Date: Oct. 30, 2025

(54) SPLIT BEARER SCHEDULING IN MULTI-PATH OPERATIONS VIA SL RELAY

(71) Applicant: InterDigital Patent Holdings, Inc., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(73) Assignee: InterDigital Patent Holdings, Inc., Wilmington, DE (US)

(21) Appl. No.: 18/855,416

(22) PCT Filed: Apr. 24, 2023
(86) PCT No.: PCT/US2023/019600

§ 371 Date: Oct. 9, 2024

Related U.S. Application Data
(60) Provisional application No. 63/334,987, filed on Apr. 26, 2022.
(60) Provisional application No. 63/359,355, filed on Jul. 8, 2022.

(51) Int. Cl. H04W 72/25; H04B 17/318; H04W 72/21

(52) U.S. Cl. CPC H04W 72/25; H04B 17/328; H04W 72/21

(57) ABSTRACT

A WTRU may receive configuration information associated with uplink transmissions over a split bearer. The split bearer may be associated with a first path and a second path. The configuration information may include radio quality thresholds associated with channel conditions over the first path and/or the second path. The WTRU may determine a (e.g., dynamic) transmission distribution percentage associated with UL transmissions over the first path and/or the second path based on at least the configuration information, channel conditions associated with the first path, and/or channel conditions associated with the second path. The WTRU may send uplink data associated with the split bearer based on the determined transmission distribution percentage. The WTRU may send an indication to the network associated with the split bearer. The WTRU may update the split buffer threshold based on channel conditions (e.g., CBR, RSRP, etc.) of the first path and/or the second path.

### CROSS-REFERENCE TO RELATED APPLICATION

This application claims priority to U.S. Provisional Patent Application No. 63/334,987 filed on Apr. 26, 2022, and U.S. Provisional Patent Application No. 63/359,355 filed on Jul. 8, 2022, the entire contents of which are each incorporated herein by reference in their entireties.

### BACKGROUND

A wireless transmit receive unit (WTRU) may be configured to communicate with one or more WTRU to network relays that include sidelink (SL) relaying. Relaying via ProSe WTRU to network relays may include extending the network coverage to an out of coverage WTRU by using PC5 links (e.g., Device to Device (D2D) between an out of coverage WTRU and a WTRU-to-network relay. For example, a ProSe WTRU-to-network relay may provide a Layer 3 (L3) forwarding function that can relay one or more (e.g., any) types of IP traffic between the remote WTRU and the network. In examples, one-to-one and/or one-to-many sidelink communications may be used between the remote WTRU(s) and the ProSe WTRU-to-network relay. For a remote WTRU and/or relay WTRU, a (e.g., only one) carrier (e.g., public safety ProSe carrier) operation may be supported (e.g., the direct link (Uu) and PC5 link may be established over the same carrier for relay/remote WTRU). In examples, the remote WTRU may be authorized by one or more upper layers and/or may be in-coverage of the public safety ProSe carrier and/or out-of-coverage on one or more (e.g., any) supported carriers including public safety ProSe carrier for WTRU-to-network relay discovery, (re) selection, and/or communication. In examples, the ProSe WTRU-to-network relay may be (e.g., always) in-coverage of EUTRAN.

### SUMMARY

A WTRU may receive configuration information associated with uplink (UL) transmissions over a split bearer. The split bearer may be associated with a first path and a second path. The WTRU may determine a transmission distribution percentage associated with UL transmissions over the first path and the second path based at least on the configuration information, channel conditions associated with the first path, and channel conditions associated with the second path. The WTRU may update the transmission distribution percentage associated with UL transmissions over the split bearer based on channel conditions associated with the first path and channel conditions associated with the second path. The configuration information may include an indication of a split buffer threshold associated with the split bearer, where the transmission distribution is further based on a buffer level of the WTRU. The configuration information may include radio quality thresholds (e.g., conditions) associated with channel conditions over each of the first path and the second path. The radio quality thresholds (e.g., conditions) may include a reference signal received power (RSRP) threshold. The radio quality thresholds may include a channel busy ratio (CBR) threshold. The channel conditions associated with the first path may include a current CBR associated with the first path. The channel conditions associated with the second path may include a current radio quality associated with the second path. The WTRU may send uplink data associated with the split bearer based on the determined transmission distribution percentage.

The WTRU may update the split buffer threshold associated with the split buffer threshold associated with the split bearer based on channel conditions associated with the first path and channel conditions associated with the second path. The WTRU may update the transmission distribution percentage associated with UL transmissions over the split bearer based on channel conditions associated with the first path and channel conditions associated with the second path. The WTRU may send an indication to the network node. The WTRU may send an indication of the updated split buffer threshold to the network. The WTRU may send an indication of the updated transmission distribution percentage to the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2A illustrates an example user plane protocol stack for a Layer 2 (L2) WTRU-to-network relay.

FIG. 2B illustrates an example control plane protocol stack for a L2 WTRU-to-network relay.

FIG. 3 illustrates an example protocol view of a split bearer associated with dual connectivity.

FIG. 4 illustrates an example split bearer protocol overview in multi-path operation.

FIG. 5 illustrates a example network associated with a split bearer.

FIG. 6 illustrates another example network associated with a split bearer.

FIG. 7 illustrates an example flowchart associated with split bearer configurations.

### DETAILED DESCRIPTION

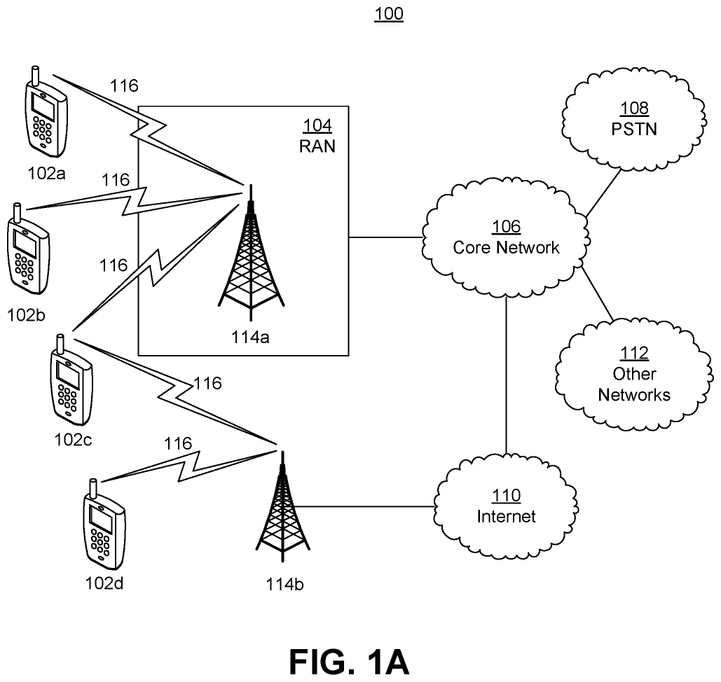

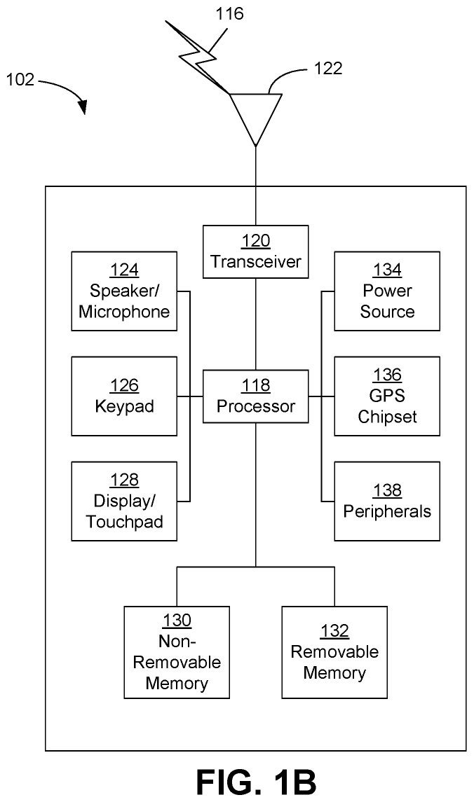

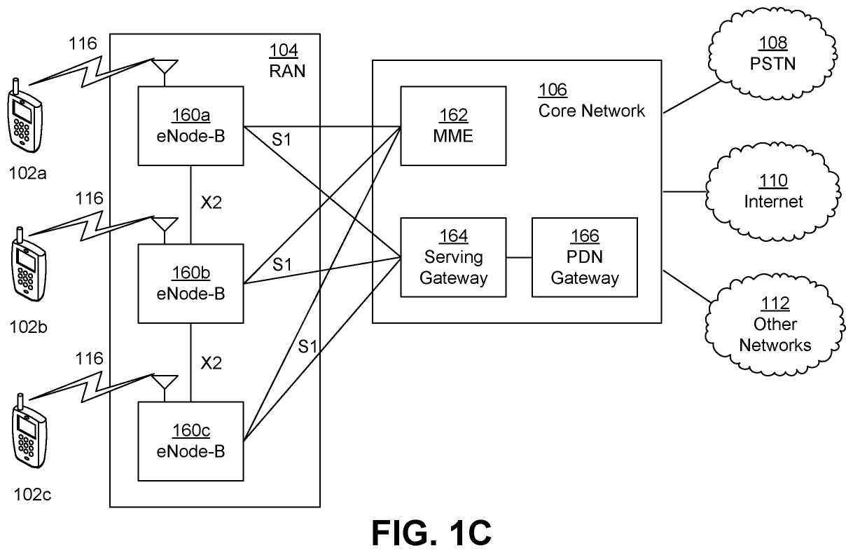

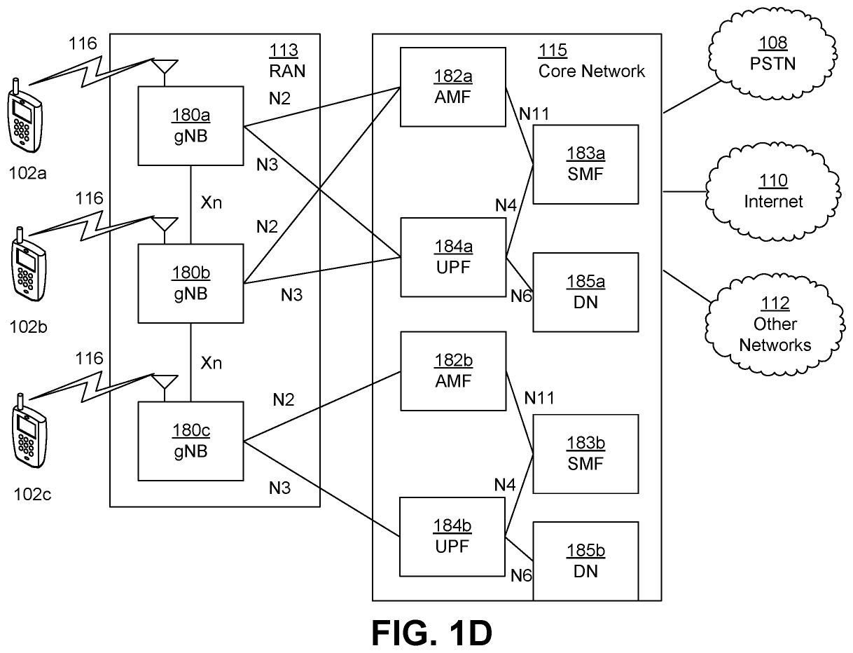

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown)

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to communicate with one or more WTRU to Network Relay(s) that include sidelink (SL) relaying. Relaying via ProSe WTRU to network relays may include extending network coverage to an out of coverage WTRU by using an interface (e.g., PC5 Device to Device (D2D) between an out of coverage WTRU and a WTRU-to-Network relay. For example, a ProSe WTRU-to-network relay may provide a Layer 3 (L3) forwarding function that can relay one or more (e.g., any) type of Internet Protocol (IP) traffic between the remote WTRU and the network. In examples, one-to-one and/or one-to-many sidelink communications may be used between the remote WTRU(s) and the ProSe WTRU-to-network relay. For one or more (e.g., both) remote WTRU and/or relay WTRU, a single carrier (e.g., public safety ProSe carrier) operation may be supported (e.g., direct link (Uu) and PC5 may be the same carrier for relay/remote WTRU). In examples, the remote WTRU may be authorized by one or more upper layers and/or can be in-coverage of the public safety ProSe carrier and/or out-of-coverage on one or more (e.g., any) supported carriers including public safety ProSe carrier for WTRU-to-network relay discovery, (re) selection, and/or communication. In examples, the ProSe WTRU-to-network relay may be (e.g., always) in-coverage of EUTRAN.

A sidelink may be used to support one or more vehicle-to-everything (V2X) related road safety services. In examples, the sidelink may support broadcast, groupcast, and/or one or more unicast communications in out-of-coverage and/or in-network coverage scenarios. Sidelink-based relaying functionality may be used to improve sidelink coverage extension, network coverage extension, and/or power efficiency. Sidelink-based relaying functionality may improve sidelink coverage extension, network coverage extension, and/or power efficiency for a wider range of one or more applications and/or services.

In examples, one or more (e.g., two) areas to improve coverage extension for sidelink-based communication may include WTRU-to-network coverage extension and/or WTRU-to-WTRU coverage extension. In WTRU-to-network coverage extension, for example, one or more WTRUs may utilize Uu coverage reachability to reach the server in a packet data network (PDN) and/or a counterpart WTRU located out of the proximity area. Certain WTRU-to-network relays may be limited to EUTRA-based technology. In WTRU-to-WTRU coverage extension, for example, proximity reachability may be limited to single-hop sidelink link, e.g., either via EUTRA-based and/or NR-based sidelink technology. Single-hop sidelink link may not be used when there is no Uu coverage. In examples, sidelink connectivity may support the one or more enhanced QoS requirements.

Single hop sidelink relays may have been introduced with one or more (e.g., several) objectives. For example, one objective may include one or more study mechanisms with minimum specification impact to support the one or more service architecture (SA) requirements for sidelink-based WTRU-to-network and/or WTRU-to-WTRU relay, focusing on one or more of the following aspects (e.g., if applicable) for layer-3 relay and/or layer-2 relay [RAN2]. The one or more following aspects for layer-3 relay and layer 2 relay may include: relay selection and/or reselection criterion and/or procedure; relay/remote WTRU authorization; QoS for relaying functionality; service continuity; security of relayed connection; and/or the impact on user plane protocol stack and/or control plane procedure (e.g., connection management of relayed connection). For example, another objective may include one or more study mechanisms to support one or more upper layer operations of discovery model/procedure for sidelink relaying, if there is no additional (e.g., new) physical layer channel/signal [RAN2].

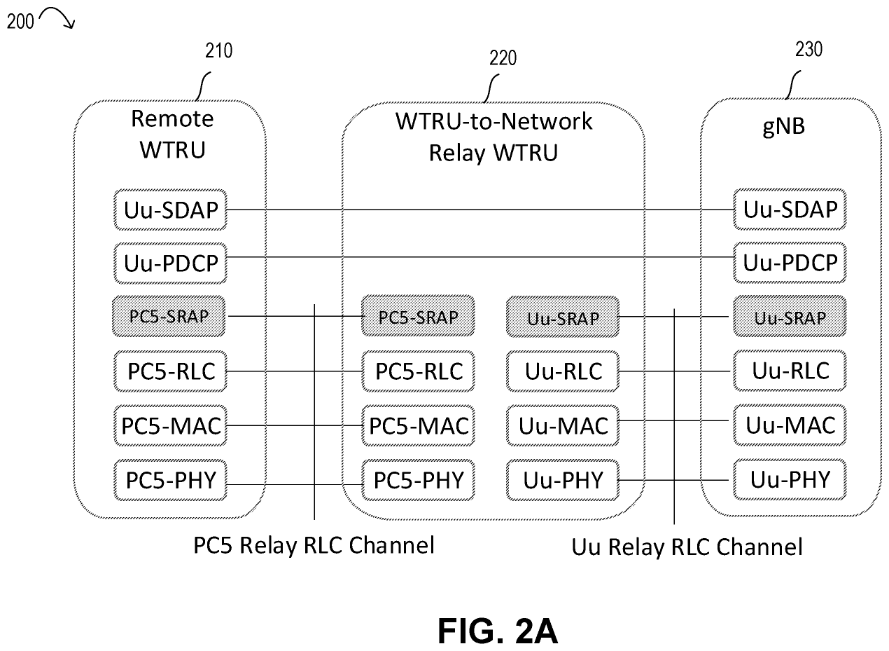

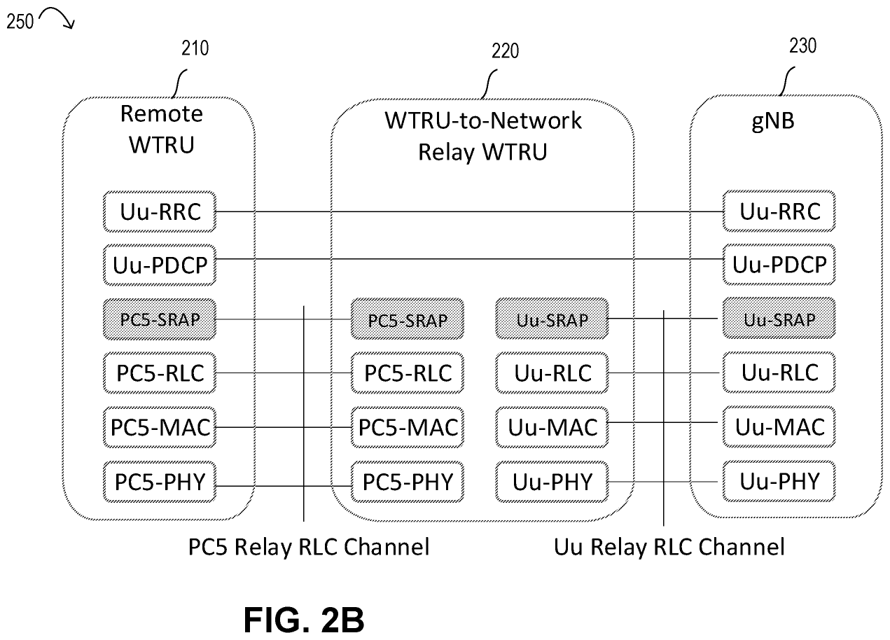

FIG. 2A illustrates an example protocol stack 200 associated with a L2 U2N relay architecture over the user plane (UP). FIG. 2B illustrates an example protocol stack 250 associated with a L2 U2N relay architecture over the control plane (CP). In examples, the Sidelink Relay Adaptation Protocol (SRAP) sublayer may be placed above the radio link control (RLC) sublayer for the CP (e.g., as illustrated in FIG. 2B) and/or the UP (e.g., as illustrated in FIG. 2A) at the PC5 interface and/or the Uu interface. The Uu service data adaptation protocol (SDAP), packet data convergence protocol (PDCP), and/or radio resource control (RRC) may be terminated between L2 U2N remote WTRU 210 and gNB 230. The sSRAP, RLC, medium access control (MAC) layer and/or the physical (PHY) layer may be terminated in one or more (e.g., each) hop (e.g., the link between the L2 U2N remote WTRU 210 and the L2 U2N relay WTRU 220 and/or the link between the L2 U2N relay WTRU 220 and the gNB 230). For L2 U2N relay, the SRAP sublayer over PC5 hop may be utilized for the purpose of bearer mapping. The SRAP sublayer may not be present over PC5 hop for relaying the L2 U2N remote WTRU's message on the broadcast control channel (BCCH) and/or paging control channel (PCCH). For L2 U2N remote WTRU's message on a specific signaling radio bearer (e.g., SRB0), the SRAP sublayer may not be present over PC5 hop, but the SRAP sublayer may be present over Uu hop for DL and/or UL.

For the uplink of the L2 U2N relay, the Uu SRAP sublayer may support UL bearer mapping between one or more ingress PC5 relay RLC channels for relaying and/or one or more egress Uu relay RLC channels over the L2 U2N relay WTRU Uu interface. For uplink relaying traffic, the one or more different end-to-end RBs (e.g., signaling radio bearers (SRBs) and/or data radio bearers (DRBs)) of the same remote WTRU 210 and/or different remote WTRUs may be multiplexed over the same Uu relay RLC channel. The Uu SRAP sublayer may support L2 U2N remote WTRU identification (ID) for the UL traffic., The identity information of L2 U2N remote WTRU Uu Radio Bearer and/or a local remote WTRU ID may be included in the Uu SRAP header at UL. The identity information of L2 U2N remote WTRU Uu radio bearer and/or a local remote WTRU ID may be included in the Uu SRAP header at UL in order for the gNB 230 to correlate the one or more received packets for the (e.g., specific) PDCP entity associated with the proper Uu radio bearer of a remote WTRU. The PC5 SRAP sublayer at the L2 U2N remote WTRU 210 may support UL bearer mapping between the one or more Remote WTRU Uu Radio Bearers and the one or more egress PC5 Relay RLC channels.

For the downlink of the L2 U2N Relay, the Uu SRAP sublayer may support DL bearer mapping at the gNB to map end-to-end radio bearer (e.g., SRB, DRB) of remote WTRU into Uu relay RLC channel over relay WTRU Uu interface. The Uu SRAP sublayer may support DL bearer mapping and/or data multiplexing between one or more (e.g., multiple) end-to-end radio bearers (e.g., SRBs and/or DRBs) of a L2 U2N remote WTRU and/or one or more different L2 U2N remote WTRUs and/or one Uu relay RLC channel over the relay WTRU Uu interface. The Uu SRAP sublayer may support remote WTRU identification for DL traffic. The identity information of Remote WTRU Uu radio bearer and/or a local remote WTRU ID may be included in the Uu SRAP header by the gNB at DL. The identity information of remote WTRU Uu radio bearer and/or a local remote WTRU ID may be included in the Uu SRAP header by the gNB at DL in order for relay WTRU to map the one or more received packets from the remote WTRU Uu radio bearer to the associated PC5 relay RLC channel (e.g., of the relay WTRU). The PC5 SRAP sublayer at the relay WTRU may support DL bearer mapping between one or more ingress Uu relay RLC channels and one or more egress PC5 relay RLC channels. The PC5 SRAP sublayer at the Remote WTRU may correlate the one or more received packets for the (e.g., specific) PDCP entity associated with the proper Uu radio bearer of a remote WTRU based on, for example, the identity information included in the Uu SRAP header.

A local remote WTRU ID may be included in the PC5 SRAP header and/or the Uu SRAP header. L2 U2N Relay WTRU may be configured by the gNB with the local remote WTRU ID. The L2 U2N relay WTRU may be configured (e.g., receive configuration information) by the gNB with the local remote WTRU ID to be used in SRAP header. The Remote WTRU may obtain the local remote ID from the gNB via one or more Uu RRC messages including RRCSetup, RRCReconfiguration, RRCResume and/or RRCReestablishment. The Uu DRB(s) and/or Uu SRB(s) may be mapped to one or more different PC5 relay RLC channels and/or Uu relay RLC channels in PC5 hop and/or Uu hop. The gNB may be responsible to avoid collision on the usage of local remote WTRU ID. The gNB may update the local remote WTRU ID by sending the updated local remote ID via RRCReconfiguration message to the relay WTRU. The serving gNB can perform a local remote WTRU ID update independent of the PC5 unicast link L2 ID update procedure.

A WTRU may be configured to perform multi-path operations with SL relay. For instance, the WTRU may be configured to perform operations for a multi-path with relay, in which the remote WTRU is connected to the network via one or more direct and/or indirect paths, which may improve the reliability, robustness, and/or throughput.

Multi-path relay may be utilized for WTRU aggregation, in which the WTRU is connected to the network via direct path and via another WTRU using a non-standardized WTRU-WTRU interconnection. WTRU aggregation may aim to provide one or more applications that include high UL bitrates on terminals. For example, WTRU aggregation may aim to provide one or more applications that include high UL bitrates on terminals when WTRUs are (e.g., too) limited by UL WTRU transmission power to achieve the desired (e.g., required) bitrate (e.g., at the edge of a cell). Additionally, or alternatively, WTRU aggregation may improve the reliability and/or stability of services. WTRU aggregation may reduce delay of one or more service(s). For example, if a channel condition of a terminal is deteriorating, another terminal may be used to make up for the traffic performance unsteadiness caused by channel condition variation.

Another objective of the multi-path operation may include studying the benefit and/or potential solutions for multi-path support to enhance reliability and/or throughput (e.g., by switching among and/or utilizing the one or more (multiple) paths simultaneously). For example, one or more multi-path operations may be used to enhance the reliability and/or throughput for a WTRU connected to the same gNB using one direct path and/or one indirect path via 1) Layer-2 WTRU-to-network relay, and/or 2) via another WTRU (e.g., where the WTRU-WTRU inter-connection may be ideal). The solutions for 1) Layer-2 WTRU-to-Network relay may be reused for the solutions for 2) another WTRU without precluding the possibility of excluding a part of the one or more solution(s) which is/are unnecessary for the operation of 2) (e.g., a WTRU connected to the gNB using an indirect path via another WTRU). WTRU-to-network relay in 1) Layer-2 WTRU-to-network relay may reuse one or more prior solutions as a baseline. Support of Layer-3 WTRU-to-network relay in multi-path scenario may include no RAN impact. Support of Layer-3 WTRU-to-network relay in multi-path scenario may include the work and/or one or more solutions that are subject to SA2 to progress.

A WTRU may be configured to perform one or more sidelink measurements and/or scheduling. In a SL operation, the WTRU may configure the associated peer WTRU to perform sidelink measurement and/or report on the corresponding PC5-RRC connection. In one or more cases, in the SL operation, the WTRU may configure the associated peer WTRU to perform the sidelink measurement(s) and/or report on the corresponding PC5-RRC connection in accordance with the sidelink measurement configuration for unicast, e.g., via an RRCReconfigurationSidelink message.

A WTRU may derive one or more sidelink measurement results, for example, by measuring one or more (e.g., multiple) Demodulation Reference Signals (DMRSs) (e.g., the DMRSs associated per PC5-RRC connection), for example, as configured by the peer WTRU. For one or more (e.g., all) sidelink measurement results, the WTRU may apply L3 filtering, e.g., before using the one or more measured results for evaluation of reporting criteria and/or measurement reporting. The sidelink reference signal received power (RSRP) may be configured as trigger quantity and/or reporting quantity.

The following measurements may be associated with the sidelink: Event S1 and/or Event S2. Event S1 may be triggered when a metric associated with the serving cell becomes stronger (e.g., better) than a threshold. Event S2 may be triggered when a metric associated with the serving becomes weaker (e.g., worse) than the threshold. The WTRU may receive one or more S1 and/or S2 based measurements (e.g., one or more reports), for example, to adjust the power level when transmitting data.

Sidelink transmissions may include one or more (e.g., two) modes for resource allocations (e.g., Mode 1 and/or Mode 2). Mode 1 may, for example, include a gNB scheduling one or more sidelink resources. Mode 2 may, for example, include the WTRU selecting (e.g., autonomously selecting) one or more sidelink resources from a set of configured and/or preconfigured sidelink resource pool(s), for example, based on a channel sensing mechanism. For the in-coverage WTRU, the WTRU may be configured to operate in Mode 1 and/or Mode 2. For the out-of-coverage WTRU, the WTRU may be configured to operate (e.g., only operate) in Mode 2.

Channel conditions may include congestion. Channel conditions associated with the first path may include congestion associated with the first path. Channel conditions associated with the second path may include congestion associated with the second path. Congestion control may be implemented in certain SL transmission (e.g., for WTRUs configured in Mode 2) to prevent a transmitting WTRU from occupying a significant amount of (e.g., too many) resources in one or more sidelink transmissions (e.g., to enhance the QoS). One or more (e.g., two) metrics (e.g., conditions) may be used to prevent the transmitting WTRU from occupying a significant amount of (e.g., too many) resources in one or more sidelink transmissions, e.g., including the Channel Busy Ratio (CBR) and/or the Channel Occupation Ratio (CR). The CBR may be referred to as the portion of subchannels whose received signal strength indicator (RSSI) exceeds a preconfigured value over a certain time duration. In consideration of a particular slot n, the CR may be defined as (X+Y)M, where X is the number of the subchannels that have been occupied by a transmitting WTRU within [n−a, n−1], Y may be the number of the subchannels that have been granted within [n, n+b], and M may be the total number of subchannels within [n−a, n+b]. For congestion control, an upper bound of CR denoted by CRₗᵢₘᵢₜ may be imposed to a transmitting WTRU, where CRₗᵢₘᵢₜ is a function of CBR and/or the priority of the one or more sidelink transmissions. The amount of resources occupied by a transmitting WTRU may not exceed CRₗᵢₘᵢₜ. Channel conditions associated with a (e.g., first) path may include a current CBR associated with the (e.g., first) path. Channel conditions associated with the second path may include a current CBR associated with the second path.

The gNB may use the CBR report to determine the pool of resources allocated to sidelink communication. For example, the gNB may increase the pool of resources if the one or more WTRUs involved in sidelink communication are reporting high CBRs. For example, the gNB may decrease the pool of resources if the CBRs reported are low.

In addition to the one or more peer WTRUs involved in sidelink operation that may configure one or more peer WTRUs (e.g., each other) for one or more measurements (e.g., determining one or more measurements either periodically and/or by S1/S2 events), the gNB may configure the remote WTRU with one or more CBR measurements, for example, for in-coverage operations (e.g., the remote WTRU may be within the coverage of the gNB). The one or more CBR measurements may be periodically performed and/or event (e.g., S1/S2 event(s) triggered. One or more (e.g., two) measurement events may be configured for CBR measurement reporting. For example, measurement event C1 and/or measurement event C2 may be configured to trigger CBR measurement reporting. Event C1 may be triggered if the CBR of a sidelink communication becomes stronger (e.g., better) than a threshold (e.g., an absolute threshold). Event C2 may be triggered if the CBR of a sidelink communication becomes weaker (e.g., worse) than a threshold (e.g., an absolute threshold).

A WTRU may be configured to include one or more split bearers (e.g., in dual connectivity (DC)). The WTRU may receive configuration information associated with uplink (UL) transmissions over a split bearer, where the split bearer may be associated with a first path (e.g., Uu and/or SL) and/or a second path (e.g., Uu and/or SL). The configuration information may include radio quality thresholds associated with channel conditions over the first path and/or the second path. In DC, the WTRU may be served by two nodes, where the two nodes (e.g., each node) may include a set of one or more cells (e.g., known as the Master Cell Group (MCG) and/or Secondary Cell Group (SCG)). A bearer may be associated (e.g., only) with the MCG and/or SCG and/or the bearer may be configured as a split bearer.

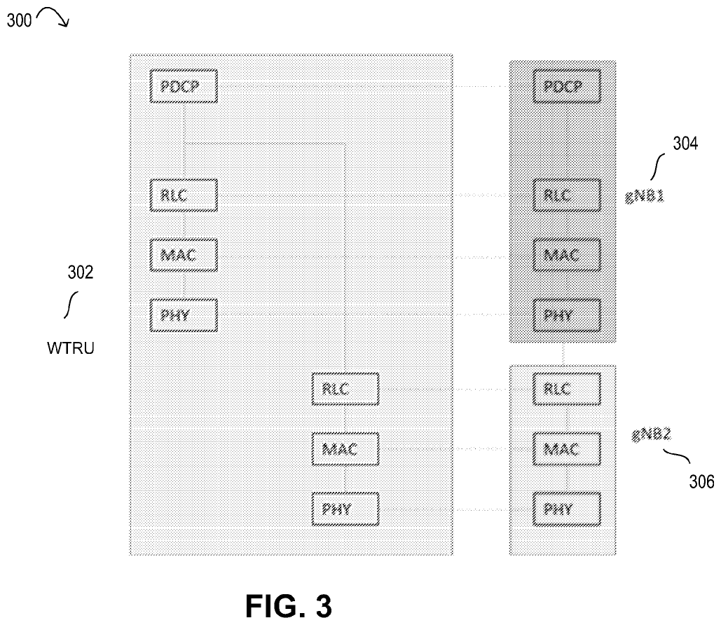

FIG. 3 illustrates an example protocol view 300 of a split bearer associated with dual connectivity. As illustrated in FIG. 3, a WTRU 302 may be associated with a PDCP entity. The peer PDCP entity on the network side may be terminated at one of the gNBs (e.g., either the master or the secondary). For example, as illustrated in FIG. 3, the PDCP entity may be terminated at the gNB 306. In the DL, the CN may send the data to the gNB where the PDCP is terminated (e.g., the gNB1 306 of FIG. 3). The network may directly send the data to the WTRU 302, e.g., via the link between that gNB (e.g., gNB1 304) and the WTRU 302 and/or the network may forward the PDCP PDUs to the gNB2 304 (e.g., via Xn interface). The gNB (e.g., gNB2 306) may send the data to the WTRU 302 via the link between the gNB and the WTRU 302.

In the UL, the WTRU may be configured with a primary path and a secondary path. The WTRU may also be configured with a threshold associated with the primary path and the secondary path (e.g., the UL split buffer threshold). If the UL buffer size for the primary path is less than the configured threshold (e.g., the UL split buffer threshold), the PDCP may push the data to the RLC associated with the primary path. If the buffer size becomes larger than the threshold (e.g., the UL split buffer threshold), the WTRU may push (e.g., based on the implementation of the WTRU) the data to either the primary path or the secondary path.

As discussed herein, when the UL buffer size for a split bearer is greater than the split buffer threshold, the WTRU may push the data to either the primary or secondary path. The WTRU may push the data to either the primary or secondary path, for example, based on the implementation of the WTRU as the scheduling of the one or more (e.g., two) link(s) may be done independently by each of the gNBs.

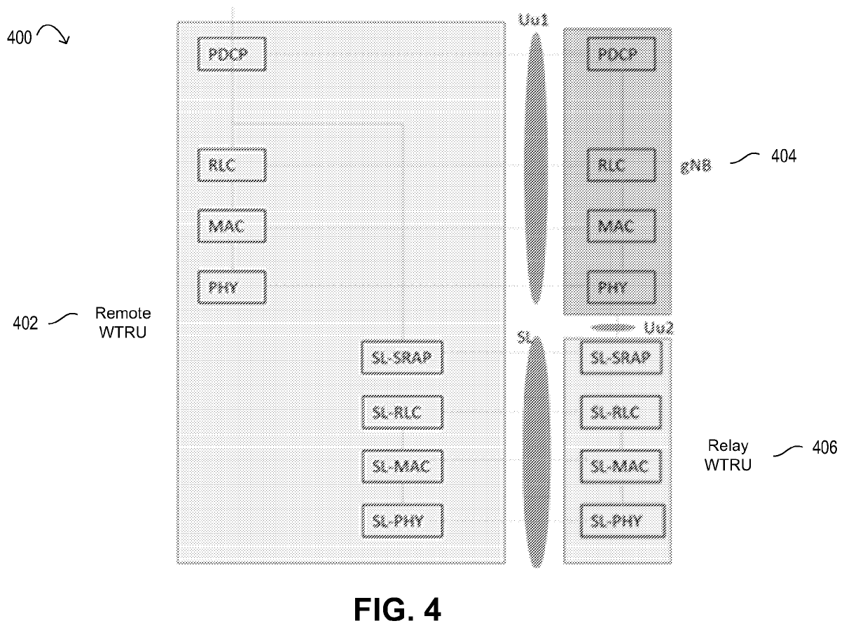

FIG. 4 illustrates an example 400 associated with a split bearer protocol overview in a multi-path operation. In multi-path operation, the direct link between the remote WTRU 402 and the gNB 404 (e.g., Uu1) and/or the backhaul link between the relay WTRU 406 and the gNB 404 may be served by the same gNB 404 and/or the same cell of the same gNB 404. If mode1 is chosen for the scheduling of the SL between the remote WTRU 402 and the relay WTRU 406, the gNB 404 may schedule one or more (e.g., all) links (e.g., Uu1, Uu2, SL). If mode2 is used and/or a resource pool was pre-configured by the gNB 404 for the SL which the remote WTRU 402 can use autonomously, the gNB 404 may determine the resource pool configuration. As such, the gNB 404 may control the scheduling over the SL (e.g., although the scheduling may not be as real-time as in the cases of mode 1). A WTRU's determination of the path selection for UL traffic of one or more split bearers after the UL split buffer threshold has been exceeded may be suboptimal (e.g., in a multi-path relay case, where the same gNB 404 is responsible for the scheduling of both links).

Although techniques are described in association with split buffers in scenarios where a remote WTRU is multi-path connected to the same gNB via a direct link (e.g., Uu link) and a SL relay, the techniques described herein may also, or alternatively, be used in other scenarios, including, e.g., in association with multi-hop scenarios (e.g., where the relay WTRU is further connected to a parent relay WTRU which is connected to a gNB).

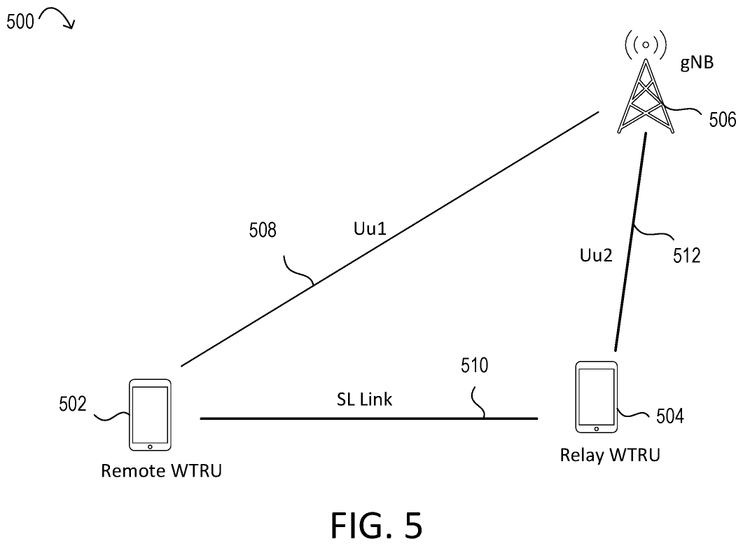

FIG. 5 depicts an example network 500. As illustrated in FIG. 5, the network 500 may include a remote WTRU 502, a relay WTRU 504, and a gNB 506. The gNB 506 may be connected to the remote WTRU 502 via a Uu1 connection 508. As described herein, the WTRU 502 may be directly connected to the gNB 506 (e.g., the network) via the Uu1 connection 508 (e.g., which may be referred to herein as a direct connection). The gNB 506 may be connected to the relay WTRU 504 via a Uu2 connection 512. The remote WTRU 502 may be connected to the relay WTRU 504 via an SL connection 510. As described herein, the WTRU 502 may be indirectly connected to the gNB 506 (e.g., the network) via the SL connection 510 (e.g., which may be referred to herein as an indirect connection).

As described herein, a split bearer may be configured with a primary path (e.g., either the Uu1 connection 508 or the SL connection 510) and/or a secondary path (e.g., either the Uu1 connection 508 or the SL connection 510). An UL split buffer threshold may be configured, e.g., where the split buffer threshold may be set to a value from 0 or infinity. For example, setting the UL split buffer threshold to 0 may indicate that there is no primary path (e.g., either the SL or the Uu link may be used). For example, setting the UL split buffer threshold to infinity may indicate that (e.g., only) the primary path is used (e.g., no matter the size of the UL buffer).

Devices, methods, and systems for split buffer scheduling in multi-path operations are discussed herein. In one or more examples, a remote wireless transmit/receive unit (WTRU) may be configured with a split bearer and/or one or more associated split buffer thresholds that are dependent on channel occupation ratio (CR)/channel busy ratio (CBR) and/or direct link (Uu)/sidelink (SL) radio quality, and/or may determine and/or use the split buffer threshold that corresponds to the configured Uu/SL related thresholds and/or current Uu/SL conditions.

In examples, a remote WTRU may be configured with a split bearer and/or associated split buffer threshold and/or one or more splitting distribution percentages between the Uu and SL that may be dependent on the CR/CBR and/or Uu/SL radio quality. The WTRU may determine the distribution percentage value that corresponds to the configured Uu/SL related thresholds and/or current Uu/SL conditions to distribute the UL data between the primary and/or secondary path according to the determined distribution percentage.

In examples, a remote WTRU may be configured with a split bearer and/or one or more associated split buffer threshold configurations that are dependent on channel occupation ratio (CR)/channel busy ratio (CBR) and/or direct link (Uu)/sidelink (SL) radio quality. The WTRU may determine and/or use the split buffer threshold that corresponds to the configured Uu/SL related thresholds, and/or current Uu/SL conditions, and/or associated splitting distribution percentage(s) between the Uu and the SL that may be dependent on the CR/CBR and/or Uu/SL radio quality. The WTRU may determine the distribution percentage value that corresponds to the configured Uu/SL related thresholds and/or current Uu/SL thresholds conditions to distribute the UL data between the primary and secondary path according to the determined distribution percentage. In examples, splitting the distribution percentages between the Uu and the SL may be dependent on the SL scheduling mode (e.g., mode 1 and/or mode 2). In examples, the WTRU may be configured to apply one or more different split bearer handling behaviors (e.g., to determine the split buffer threshold and/or split bearer distribution factor depending on one or more Uu/SL radio thresholds/conditions and/or SL CBR) that are dependent on the SL scheduling mode (e.g., mode 1 and/or mode 2).

In examples, a remote WTRU may be configured to indicate preferred split bearer handling behavior (e.g., preferred primary path, preferred split buffer threshold, preferred splitting distribution percentages, preferred split bearer distribution factor, etc.) depending on one or more radio thresholds/conditions (e.g., Uu reference signals received power (RSRP)/reference signal received quality (RSRQ), SL RSRP/RSRQ/SINR, SL CBR/CR) and/or one or more current UL buffer levels at the WTRU (e.g., total UL buffer, total buffer over the SL, total buffer over the Uu, buffer level for a given bearer and/or one or more sets of bearers, etc.,).

A WTRU may receive configuration information associated with uplink (UL) transmissions over a split bearer. The split bearer may be associated with a first path and a second path. The WTRU may determine a transmission distribution percentage associated with UL transmissions over the first path and the second path based at least on the configuration information, channel conditions associated with the first path, and channel conditions associated with the second path. The WTRU may update the transmission distribution percentage associated with UL transmissions over the split bearer based on channel conditions associated with the first path and channel conditions associated with the second path. The configuration information may include an indication of a split buffer threshold associated with the split bearer, where the transmission distribution is further based on a buffer level of the WTRU. The configuration information may include radio quality thresholds (e.g., conditions) associated with channel conditions over each of the first path and the second path. The radio quality thresholds (e.g., conditions) may include a reference signal received power (RSRP) threshold. The radio quality thresholds may include a channel busy ratio (CBR) threshold. The channel conditions associated with the first path may include a current CBR associated with the first path. The channel conditions associated with the second path may include a current radio quality associated with the second path. The WTRU may send uplink data associated with the split bearer based on the determined transmission distribution percentage.

The WTRU may update the split buffer threshold associated with the split buffer threshold associated with the split bearer based on channel conditions associated with the first path and channel conditions associated with the second path. The WTRU may update the transmission distribution percentage associated with UL transmissions over the split bearer based on channel conditions associated with the first path and channel conditions associated with the second path. The WTRU may send an indication to the network node. The WTRU may send an indication of the updated split buffer threshold to the network. The WTRU may send an indication of the updated transmission distribution percentage to the network.

A split buffer threshold and/or a (e.g., dynamic) transmission distribution percentage may be based on one or more channel conditions over a first path and/or a second path. For example, the channel conditions may include radio conditions, as described herein. For example, the channel conditions may include congestion, as described herein.

A split buffer threshold may depend and/or be modified (e.g., by the remote WTRU) based on the CBR and/or the CR. In examples, the remote WTRU (e.g., the remote WTRU 502) may be configured to modify the UL split buffer threshold associated with a split bearer based on the SL CBR and/or CR (e.g., and/or any other suitable measurement associated with the radio conditions over the SL). For example, the WTRU may be configured with one or more (e.g., multiple) split buffer threshold values, where the one or more (e.g., each) split buffer threshold values correspond with a (e.g., specific) range of CBR/CR values. For instance, the WTRU may be configured with a first split buffer threshold value, threshold1, that is used if the CBR is below a first CBR threshold, cbr1, a second split buffer threshold value, threshold2, if the CBR values is between cbr1 and a second CBR threshold, cbr2, and/or a third split buffer threshold value, threshold3, that is used if the CBR is greater than cbr2. The WTRU may also, or alternatively, be configured with a baseline split buffer threshold value and/or a scaling factor that depends on the CBR. For example, the WTRU may be configured to use a baseline threshold for CBRs below cbr1. Also, or alternatively, the WTRU may be configured to use a baseline threshold value and/or a scaling factor to increase and/or decrease the threshold by a percentage difference between the current CBR and cbr1. The WTRU may be configured with a baseline buffer threshold value and/or may apply a delta value that depends on the CBR. For example, the WTRU may use a baseline threshold for one or more CBRs below cbr1, and/or may apply an increase or decrease of a certain amount and/or percentage for one or more (e.g., every) CBR increase of a certain amount or percentage.

A WTRU may switch the primary path of a certain split bearer based on the CBR. For example, the WTRU may be configured to switch the primary path to the SL if the SL CBR is below a given CBR threshold (e.g., cbr1). For example, the WTRU may be configured to switch the primary path to the Uu if the SL CBR is above a given threshold (e.g., cbr2).

A split buffer threshold may depend on the radio conditions (e.g., the current radio condition) of the SL and/or the Uu. The remote WTRU may be configured to modify the UL split buffer threshold used by a split bearer based on the radio conditions (e.g., radio quality and/or threshold(s)) associated with the SL and/or Uu (e.g., RSRP, reference signals received power (RSRQ), signal to interference and noise ratio (SINR), etc.). For example, the radio quality thresholds may include a RSRP threshold. For example, the radio quality thresholds may include a CBR threshold. For example, the WTRU may be configured with one or more (e.g., multiple) split buffer threshold values, in which the one or more (e.g., each) split buffer threshold values correspond to a (e.g., specific) range of one or more SL radio conditions (e.g., threshold1 may be used as the split buffer threshold value if the SL radio quality is below sl_thresh1, threshold2 may be used as the split buffer threshold value if the SL radio quality is between sl_thresh1 and sl_thresh2, and/or threshold3 may be used as the split buffer threshold value if the SL radio quality is above sl_thresh2, etc.). The WTRU may be configured with a baseline buffer threshold value and/or may be configured to apply a delta value that depends on the SL radio conditions. For example, the WTRU may be configured with a baseline threshold that is used as the split buffer threshold value if the SL radio quality is below sl_quality1. The WTRU may increase and/or decrease the baseline threshold, e.g., based on the percentage difference between the current SL radio quality and a given radio quality, sl_quality1, etc. The WTRU may also, or alternatively, be configured with multiple split buffer threshold values, in which each of the split buffer threshold values correspond to a range of one or more Uu radio conditions (e.g., threshold1 for Uu radio quality below uu_thresh1, threshold2 for Uu radio quality between uu_thresh1 and uu_thresh2, threshold3 for Uu radio quality above uu_thresh2, etc.). Also, or alternatively, the WTRU may be configured with a baseline buffer threshold value and/or may be configured to apply a delta value that depends on one or more the Uu radio conditions (e.g., use baseline threshold for Uu radio quality below uu_quality1, increase and/or decrease the threshold by the percentage difference between the current Uu radio quality and uu_quality1, etc.). Channel conditions associated with the (e.g., second) path may include a current radio quality associated with the (e.g., second) path.

A WTRU may use a split buffer threshold in one or more combinations, for example, as described herein. One or more of the following may apply. A WTRU may use a split buffer threshold in one or more combinations, for example, based on a comparing the SL and Uu radio conditions to a threshold. A WTRU may use a split buffer threshold in one or more combinations, for example, based on a separate comparison of the SL to one threshold and the Uu to another threshold. A WTRU may use a split buffer threshold in one or more combinations, for example, based on a comparison of the CBR to one threshold, the SL to a second threshold, and/or the Uu to a third threshold. For example, the WTRU may be configured with one or more (e.g., multiple) split buffer threshold values, in which each split buffer threshold value corresponds to a comparison of the SL and/or Uu radio conditions (e.g., threshold1 when the SL's radio quality is a better than the Uu's radio conditions by a certain threshold, threshold2 when SL's radio quality is a worse that the Uu's radio conditions by a certain threshold, etc.).

A WTRU may be configured to calculate a scaling factor and/or an applied delta value based on one or more of the threshold comparisons described herein (e.g., to consider the one or more CBR and/or SL/Uu radio conditions). The WTRU may limit the scaling factor and/or applied delta value to a configured maximum and/or minimum threshold. For example, if the calculated buffer threshold is above the maximum threshold, the WTRU may be configured to use the maximum threshold. For example, if the calculated buffer threshold is below the minimum threshold, the WTRU may be configured to use the minimum threshold.

A WTRU (e.g., remote WTRU) may be configured to switch the primary path of a split bearer based on the SL's radio condition and/or Uu's radio conditions (e.g., the SL's current radio condition and/or Uu's current radio conditions). For example, the WTRU may be configured to switch the primary path of a split bearer to the SL if the SL radio quality is above a certain threshold. For example, the WTRU may be configured to switch the primary path of a split bearer to the Uu if the Uu radio quality is above a certain threshold. For example, the WTRU may be configured to switch the primary path of a split bearer to the Uu if the Uu radio quality is above a certain threshold and/or the SL radio quality is below another threshold.

A WTRU may be configured to perform fractional distribution between the paths associated with a split bearer. The (e.g., remote) WTRU may be configured to distribute the UL data between the Uu and SL, for example, based on a dynamic transmission distribution percentage (e.g., 20% on the Uu, 80% on the SL). For example, the (e.g., remote) WTRU may send uplink data associated with the split bearer based on the determined transmission distribution percentage. The WTRU may update the transmission distribution percentage associated with UL transmissions over the split bearer based on channel conditions associated with the first path and/or channel conditions associated with the second path. The (e.g., remote) WTRU may be configured to set the dynamic transmission distribution percentage based on one or more (e.g., several) factors (e.g., conditions), such as, but not limited to, CBR, SL radio quality, Uu radio quality, congestion, and/or the like. The WTRU may determine the transmission distribution percentage associated with UL transmissions over the split bearer based on, for example, configuration information, channel conditions (e.g., current channel conditions) associated with the first path, and/or channel conditions associated with the second path. For example, the WTRU may be configured with multiple distribution percentage values, in which each distribution percentage value corresponds to a (e.g., specific) range of CBRs (e.g., percentage1 of UL data is transmitted on SL if the CBR is below cbr1, percentage2 of UL data is transmitted on SL if CBR is between cbr1 and cbr2, percentage 3 of UL data is transmitted on SL if CBR is between cbr2 and cbr3, and/or UL data is not transmitted on SL if the CBR is above cbr3, etc.). The WTRU may be configured with a baseline distribution percentage value and/or a scaling factor that depends on the CBR. For example, the WTRU may be configured with a baseline distribution percentage, and decrease and/or increase the baseline distribution percentage threshold based on the percentage difference between the current CBR and cbr1. For example, the WTRU may be configured with multiple distribution percentage values, in which the each distribution percentage value corresponds to a (e.g., specific) range of SL radio quality (e.g., UL data is not transmitted on SL if SL radio quality is below sl_quality1, percentage1 of UL data is transmitted on SL if SL radio quality is between sl_quality1 and sl_quality2, and/or percentage 2 of UL data is transmitted on SL if the SL radio quality is between sl_quality 2 and sl_quality3, etc.). The WTRU may also, or alternatively, be configured with multiple distribution percentage values, in which each distribution percentage value corresponds to a (e.g., specific) range of Uu radio quality (e.g., UL data put is not transmitted on Uu if Uu radio quality is below uu_quality1, percentage 1 of UL data is transmitted on Uu if Uu radio quality is between uu_quality1 and uu_quality2, percentage2 of UL data is transmitted on Uu if the Uu's radio quality is between uu_quality 2 and uu_quality3, etc.).

A WTRU may distribute the percentages in one or more (e.g., any) of the combinations described herein. For example, the WTRU may distribute the percentages based on a comparison between the SL radio conditions and Uu radio conditions to a threshold. For example, the WTRU may distribute percentages based on separate comparison of the SL's radio conditions to one threshold and the Uu's radio conditions to another threshold. For example, the WTRU may distribute the percentages based on the comparison of the CBR to one threshold, the SL to a second threshold, and/or the Uu to a third threshold. In examples, the WTRU may be configured with multiple distribution percentage values, in which each distribution percentage value corresponds to a condition associated with the SL's radio quality and/or Uu's radio quality. For example, the WTRU may be configured with percentage1 when SL radio quality is a certain threshold above the Uu radio conditions. For example, the WTRU may be configured with percentage2 when SL radio quality is a certain threshold below the Uu radio conditions.

A transmission distribution percentage may be (e.g., further) limited based on a split buffer threshold associated with the split bearer. For example, when the buffer size is below the split buffer threshold, the WTRU may (e.g., only) use the primary path. Once the buffer size is greater than the split buffer threshold, the WTRU may, for example, start distributing the data according to the configured and/or determined percentage distributions (e.g., until the buffer level/size of the WTRU falls below the buffer split threshold again).

A transmission distribution percentage may be (e.g., further) limited by a configured distribution duration and/or a split buffer threshold. For example, the transmission distribution percentage may be based on a buffer level of the WTRU. For example, when the buffer size is below a first split buffer threshold, the WTRU may be configured to (e.g., only) use the primary path. Once the buffer size is passed (e.g., greater than the first split buffer threshold), the WTRU may, for example, distribute the data according to the configured and/or determined percentage distribution (e.g., until the buffer level/size falls below/is less than the threshold, and/or the configured duration has elapsed since the distribution to the secondary has started, and/or whichever happens first).

A transmission distribution percentage may be (e.g., further) limited by a second split buffer threshold. The second split buffer threshold may be, for example, less than (e.g., smaller than) another (e.g., the legacy) split buffer threshold. The WTRU may use the second split buffer threshold to determine when to stop the usage of the secondary path. For example, when the buffer size is less than the first split buffer threshold, the WTRU may be configured to (e.g., only) use the primary path. Once the buffer size is passed (e.g., greater than the first split buffer threshold), the WTRU may, for example, distribute the data according to the configured and/or determined percentage distribution (e.g., until the buffer size falls below/is less than the second split buffer threshold). If, for example, the buffer size is less than the second split buffer threshold, the WTRU may distribute data using only the primary path, which may allow the WTRU to prevent (e.g., frequent) switching between using the secondary and primary paths.

Additionally, or alternatively, the usage of the second split buffer threshold may be combined with the usage of the distribution duration, as discussed herein. For example, the WTRU may be configured to use the secondary path until the configured duration has elapsed and/or the buffer size has fallen below/is less than the second threshold.

A WTRU may be configured to apply a distribution factor. The WTRU may determine (e.g., calculate) the distribution factor according to one or more (e.g., any) of the distribution examples discussed herein (e.g., consider the one or more CBR and/or SL/Uu radio conditions. The WTRU may limit the applied distribution factor to a configured maximum and/or minimum threshold percentage values. For example, the WTRU may be configured to route a minimum of 20% of the split buffer data and/or a maximum of 50% of the split buffer data via the SL. For example, if the WTRU calculates a distribution factor that is below 20%, the WTRU may set the distribution factor to 20%. For example, if the WTRU calculates a distribution factor that is above 50%, the WTRU may set the distribution factor to 50%.

A WTRU may be configured to consider the maximum data allowed over each path, as described herein. In examples, one or more split bearers may be configured to allow a maximum amount of data to be transmitted over a given link. For example, a first portion of UL data may be sent over the SL and/or Uu, where the first portion may not exceed a first maximum of UL data. For example, a second portion of data may be sent over the SL and/or Uu, where the second portion may not exceed a second maximum of UL data.

For a given split bearer, a remote WTRU may transmit up to a maximum amount of data (e.g., ×MBs) over one path (e.g., primary path), and/or the remote WTRU may be configured to transmit the remainder of the data via the other path.

A maximum data limitation may be (e.g., only) specific to a given duration (e.g., a data rate limitation). For example, the remote WTRU may be configured to transmit up to x Mbps UL transmission over the primary path, and/or the remote WTRU may be configured to start using the secondary path when the data rate over the primary path (sur) passes x Mbps.

A remote WTRU may be configured to perform a combination of the techniques described herein to transmit data (e.g., uplink data) over a split bearer. For example, the remote WTRU may be configured to transmit a certain amount of data over a path based on the comparison between the SL's and/or Uu's radio conditions to a threshold. In another example, the remote WTRU may be configured to transmit a certain amount of data over a path based on separate comparison of the SL's radio conditions to one threshold and the Uu's radio condition to another threshold. In another example, the remote WTRU may be configured to transmit a certain amount of data over a path based on the comparison of the CBR to one threshold, the SL's radio quality (e.g., RSRP, RSRQ, etc.) to a second threshold, and the Uu's radio quality to a third threshold. In one or more cases, the remote WTRU may be configured with multiple values of maximum data or data rate allowed for each path, in which each value corresponds to a condition of the SL's and Uu's radio quality.

A WTRU may be configured to consider UL data traffic. In certain scenarios, the path selection for the transmission of UL data over a split bearer may (e.g., only) consider the buffer level of that particular bearer. In certain scenarios, the WTRU may be configured to consider all UL data traffic (e.g., as opposed to just UL data associated with a split bearer).

A remote WTRU may be configured with a different (e.g., new) split buffer threshold (e.g., total_buffer_split_thresold) that is related to the buffer level of more than one bearer. For example, the remote WTRU may be configured with a split buffer threshold that is related to the buffer level of all the bearers. In another example, the remote WTRU may be configured with a split buffer threshold that is related to the bearers of a certain QoS type. In another example, the remote WTRU may be configured with a split buffer threshold that is related to a subset of pre-defined bearers, for example, but not limited to pre-defined bearers based on a bearer ID list.

In certain scenarios, a remote WTRU may be configured to specify a separate total_split_buffer_threshold for each link (e.g., threshold_uu and threshold_sl). For example, a first buffer threshold may be associated with a first path (e.g., threshold_uu). For example, a second buffer threshold may be associated with a second path (e.g., threshold_sl). For the cases when the total UL buffer size on the Uu is greater than the specified threshold for the Uu link, the remote WTRU may be configured to transmit UL data over the SL. When the total UL buffer size on the Uu is greater than the specified threshold for the Uu link, the remote WTRU may be configured to push UL data to the SL even if the bearer for which the particular data belongs is configured to have the Uu as the primary path and the split buffer threshold for that bearer has not been surpassed. For the cases in which the total UL buffer size on the SL is greater than the specified threshold for the SL link, the remote WTRU may be configured to transmit UL data over the Uu. In one or more cases in which the total UL buffer size on the SL is greater than the specified threshold for the SL link, the remote WTRU may be configured to push UL data to the Uu if the bearer for which the data belongs is configured to have the SL as the primary path and the split buffer threshold for that bearer has not been surpassed.

The WTRU may combine the threshold configurations described herein with the threshold configuration that considers total buffer size. The WTRU may update the buffer threshold associated with the split bearer based on channel conditions associated with the first path and/or channel conditions associated with the second path. For example, the WTRU may update threshold_uu and/or threshold_sl based on one or more of the: CBR/CR, Uu's radio quality, SL's radio quality, congestion over the SL, congestion over the Uu, and/or a comparison between the Uu's radio quality and the SL's radio quality. The WTRU may also, or alternatively, configure different distribution percentages between the Uu and SL. For example, the WTRU may configure different distribution percentages between the Uu and SL based on the pending UL buffer size on the Uu and/or SL. Also, or alternatively, the WTRU may configure the different distribution percentages between the Uu and SL based on one or both of threshold_uu and threshold_sl.

In certain scenarios, the remote WTRU may be configured to reserve a certain amount of UL buffer space for SL communications (e.g., only SL communication). For example, the remote WTRU may be configured to reserve a certain amount of UL buffer space for direct SL communication between the remote WTRU and the relay WTRU that is not destined to the gNB.

The remote WTRU may be configured to consider the serving cells of the Uu and SL. For example, the remote WTRU may perform any of the techniques discussed herein if the SL (e.g., the relay WTRU) is being served by the same cell as the Uu link.

The remote WTRU may be configured to apply different configurations for each link associated with a split bearer based on whether the SL is being served by a different cell from the cell serving the Uu link. For example, the remote WTRU may be configured with one or more (e.g., two) sets of configurations associated with a split bearer. A first configuration may be used if the Uu link and the SL are served by the same cell, and another configuration may be used if the Uu link and the SL are served by different cells. Also, or alternatively, the remote WTRU may be configured with a configuration that is used if the Uu link and the SL are served by the same cell, and be provided with information associated with converting the buffer thresholds or distribution factors included in that configuration if the Uu link and the SL are served by different cells (e.g., applying a delta value or a scaling factor).

As described herein, a remote WTRU may be configured to apply different configurations depending on whether the SL is being served by a gNB different from the gNB serving the Uu link (e.g., WTRU is configured in DC operation, WTRU is configured to identify the gNB ID from the cell identity, and/or the like). For example, the remote WTRU may be configured with one or more (e.g., two) sets of configurations. A first configuration may be used if the Uu link and the SL are served by same gNBs. And another may be used if the Uu link and the SL are served by different gNBs. Also, or alternatively, the remote WTRU may be configured with a configuration that is used if the Uu link and the SL are served by the same gNB and be provided with information associated with converting the buffer thresholds or distribution factors included in that configuration if the Uu link and the SL are served by different cells (e.g., applying a delta value or a scaling factor).

As described herein, a given split bearer configuration may be applicable to one or more (e.g., all) bearers. For example, each split bearer may be associated with a respective split buffer configuration. The split buffer configuration may include: a set of split buffer thresholds that correspond to specific range of CBR/CR values, a baseline threshold and scaling factor, and/or delta values and information associated with applying the scaling factor/delta values.

As described herein, a split bearer configuration may be configured per split bearer. A split bearer configuration, as described herein, may also apply to a set of split bearers (e.g., all split bearers having the Uu as the primary path, and/or all split bearers having the SL as the primary path). Also, or alternatively, the split bearer configuration techniques described herein may be applicable to a set of split bearers, including, for example, bearers within a list of bearers, bearers with certain bearer IDs, bearers with a certain QoS type, and/or the like.

A split bearer may share part of another split bearer configuration (e.g., configurations that are common for all split bearers) and also, or alternatively, include other parts that are bearer specific (e.g., for each bearer, for a subset of bearers, and/or the like). For example, each split bearer may have a baseline split buffer threshold, and all the bearers or a subset of the bearers (e.g., specified in a list of bearer IDs and/or associated with certain QoS types) may share a scaling factor or a delta value to apply when the CBR is greater than a certain value.

The remote WTRU may send an indication to a network about a (e.g., any) modified behavior (e.g., a WTRU's modification of a split bearer threshold). For example, the remote WTRU may be configured to send an indication to the network based on a modification. The remote WTRU may be configured to send an indication to the network if, for example, the behavior regarding the split bearer operation is updated (e.g., using any of the techniques described herein). For example, the remote WTRU may be configured to update the split bearer buffer threshold based on a change to one or more of the: CBR and/or CR, the SL's radio quality (e.g., RSRP, RSRQ, etc.), and/or the Uu's radio quality (e.g., RSRP, RSRQ, etc.). The WTRU may send an indication of the updated split buffer threshold to the network. Also, or alternatively, the remote WTRU may be configured to switch the primary path of a split bearer based on a change to one or more of the: CBR/CR, the SL's radio quality (e.g., RSRP, RSRQ, etc.), and/or the Uu's radio link quality (e.g., RSRP, RSRQ, etc.). The remote WTRU may be configured to update the distribution percentage between the primary and secondary links based on a change to one or more of the: CBR/CR, the SL's radio quality (e.g., RSRP, RSRQ, etc.), and/or the Uu's radio link quality (e.g., RSRP, RSRQ, etc.). The WTRU may send an indication of the updated transmission distribution percentage to the network.

The remote WTRU may be configured to provide the indication to the network about modification to the split buffer configuration via a dedicated message (e.g., RRC, MAC CE, and/or the like). For example, the WTRU may be configured to include the indication in other messages (e.g., a measurement report, a SL buffer status report (BSR), Uu BSR sent to the gNB, and/or the like).

A remote WTRU may be configured to consider the scheduling mode for a SL connection. For example, the remote WTRU may be configured to apply any of techniques described herein (e.g., those related to split buffer thresholds or split bearer distribution factors that are dependent on the SL radio quality or SL congestion) irrespective of the scheduling mode used over the SL (e.g., mode 1 or mode 2).

Also, or alternatively, the remote WTRU may be configured to apply the techniques described herein (e.g., those related to split buffer thresholds and/or split bearer distribution factors that are dependent on the SL's radio quality or SL's congestion) when the scheduling mode used over the SL is mode 1. For example, the remote WTRU may be configured to apply other (e.g., legacy) split buffer handling when mode 2 scheduling is used over the SL. For example, the SL scheduling mode may be initially set to mode 1 and the WTRU may perform split bearer handling configuration according to the techniques described herein. If the SL scheduling mode is changed to mode 2 (e.g., based on an instruction/configuration received from the network), the WTRU may save the current split bearer handling configuration and revert to another from (e.g., legacy) split bearer handling. If the SL scheduling mode is changed back to mode 1, the WTRU may restore the saved split bearer handling configuration and operate accordingly.

A remote WTRU may be configured to apply the techniques described herein (e.g., those related to split buffer thresholds or split bearer distribution factors that are dependent on the SL radio quality or SL congestion) when the scheduling mode used over the SL is mode 2. The remote WTRU may also, or alternatively, be configured to apply other split buffer handling techniques when mode 1 scheduling is used over the SL. For example, the SL scheduling mode may be initially set to mode 2 and the WTRU may be configured with a split bearer handling configuration according to the techniques discussed herein. If the SL scheduling mode is changed to mode 1 (e.g., based on an instruction/configuration received from the network), the WTRU may save the current split bearer handling configuration and revert to another form of (e.g., legacy) split bearer handling. If the SL scheduling mode is changed back to mode 2, the WTRU may restore the saved split bearer handling configuration and operate accordingly.

The split bearer configuration techniques may also be applicable to one or more bearers when the SL scheduling is in mode 1. For example, the split bearer techniques described herein may also, or alternatively, be applicable to one or more bearers configured in mode 2. The split bearer techniques described herein may be applicable to one or more bearers irrespective of the scheduling mode (e.g., for both mode 1 and mode 2).

A remote WTRU may be configured with one or more (e.g., two) sets of split bearer configurations. For example, a first set of the split bearer configurations may be used when the SL scheduling is mode 1, and another set of the split bearer configurations may be used when the SL scheduling is mode 2. The two configurations may be independent from each other. In certain scenarios, the WTRU may receive a split bearer configuration that is associated with a first mode (e.g., mode 1 or mode 2), and may derive the configuration for another mode (e.g., mode 2 when the mode 1 configuration is received, or mode 1 when the mode 2 configuration is received) by applying a certain delta configuration/value on top of the received configuration associated with the first mode.

If, for example, the SL scheduling mode is mode 2, the remote WTRU may be configured to consider the total number of resources that are pre-configured for the SL when deciding whether to transmit the split bearer data over the Uu or the SL. For example, the WTRU may be provided with a configuration to calculate the split buffer threshold based on Uu's radio quality, the SL's radio quality, and/or the SL's CBR/CR, as discussed herein. Such configuration may be associated with a given value or range of values of the number of SL resources pre-configured for mode 2. If, for example, the network reconfigures the SL resources for mode2, the WTRU may perform the calculation of the split buffer threshold according to the received configuration. The WTRU may scale the value up or down based on whether the number of SL resources that are now configured for mode 2 are below or above the SL resource value (e.g., or range of values) associated with the split buffer configuration. For example, if the SL resources that are now configured correspond to x % of the SL resources associated with the received split bearer configuration (e.g., where x<100%), the WTRU may scale up the split buffer threshold for split bearers with the primary path as the Uu, and the WTRU may scale down the split buffer threshold for split bearers with the primary path as the SL (e.g., to compensate for the lower number of resources currently available over the SL as compared to the level of resources associated with the split bearer handling configuration). Similarly, if the SL resources that are now configured correspond to y % of the SL resources associated with the configuration (e.g., y>100%), the WTRU may scale down the split buffer threshold for split bearers with the primary path as the Uu, and the WTRU may scale up the split buffer threshold for split bearers with the primary path as the SL (e.g., to take advantage of the higher number of resources currently available over the SL as compared to the level of resources associated with the split bearer handling configuration).

A WTRU may provide an indication to the network about the WTRU's preferred split bearer configuration. For example, the remote WTRU may be configured to send an indication to the network that indicates the WTRU's preferred handling of split bearers. For example, the WTRU may indicate to the network that the WTRU prefers the primary path for a given bearer (e.g., and/or a set of split bearers) to be switched to the Uu (e.g., if it was previously the SL) or the SL (e.g., if it was previously the Uu). In another example, the WTRU may indicate a preferred split buffer threshold level for a given split bearer (e.g., or set of split bearers) to the network. In another example, the WTRU may indicate the preferred split bearer distribution factors/percentages for the primary and secondary paths of a given split bearer (e.g., or a set of split bearers) to the network. In another example, the WTRU may indicate the WTRU's preference to modify the bearer type of a given non-split bearer or a group of non-split bearers to a split bearer to the network. In one or more cases, the WTRU may indicate the WTRU's preference to modify the bearer type of a given non-split bearer or a group of non-split bearers to a split bearer to the network (e.g., and include preferred primary paths and split buffer thresholds or distribution factors in said indication). In another example, the WTRU may indicate the WTRU's preference to modify the bearer type of a given split bearer or a group of split bearers to a non-split bearer to the network. In one or more cases, the WTRU may indicate to the network to modify the bearer type of a given split bearer or a group of split bearers to a non-split bearer and to include preferred bearer association (e.g., association to the Uu or the SL).

A WTRU may provide the triggering of the indication to the network about the preferred split bearer handling.

The WTRU may transmit the indication to the network about the WTRU's preferred split bearer configuration based on the radio conditions on the Uu and/or SL. For example, the remote WTRU may be configured to request a change of a split bearer's primary path to be the SL when the SL's CBR is below a certain threshold. In another example, the remote WTRU may be configured to request a change of a split bearer's primary path to be the SL when the SL's RSRP/RSRQ is above a certain threshold. In another example, the remote WTRU may be configured to request a change of a split bearer's primary path to be the SL when the Uu's RSRP/RSRQ is below a certain threshold. In yet another example, the remote WTRU may be configured to request a change of a split bearer's primary path to be the SL when a combination of one or more of the following occur: the SL's CBR is below a certain threshold, the SL's RSRP/RSRQ is above a certain threshold, and/or the Uu's RSRP/RSRQ is below a certain threshold.

A remote WTRU may be configured to request a change of the split bearer's primary path to the Uu for similar reasons to those discussed herein with requesting a change of a split bearer's primary path to be the SL (e.g., requesting a change when one or more of the following occur: the SL's CBR is below a certain threshold, the SL's RSRP/RSRQ is above a certain threshold, and/or the Uu's RSRP/RSRQ is below a certain threshold).

The WTRU may be triggered to transmit the indication to the network about the WTRU's preferred split bearer configuration based on buffer levels at the WTRU. For example, a WTRU may transmit an indication of the WTRU's preferred split buffer configuration based on one or more of: a total UL buffer level at the WTRU being above/below a certain threshold; a total UL buffer level at the WTRU that is pending to be sent over the Uu being above/below a certain threshold; a total UL buffer level at the WTRU that is pending to be sent over the SL being above/below a certain threshold; a total UL buffer level at the WTRU that belongs to a certain LCID (e.g., or LCG) or a set of LCIDs (e.g., or LCGs) being above/below a certain threshold, etc.

The WTRU's preferred split bearer configuration indication may be applicable to multiple (e.g., all) split bearers.

The WTRU's preferred split bearer configuration indication may be applicable to one bearer or a subset of bearers (e.g., those in which WTRU included the bearer ID(s) in the preference indication).

The WTRU's preferred split bearer configuration indication may be provided to the network via a dedicated message (e.g., via RRC WTRU assistant information, MAC CE, etc.).

The WTRU's preferred split bearer configuration indication may be provided in other messages. For example, the WTRU may include the indication in a measurement report. In another example, the WTRU may include the indication in SL or Uu BSR sent to the gNB.

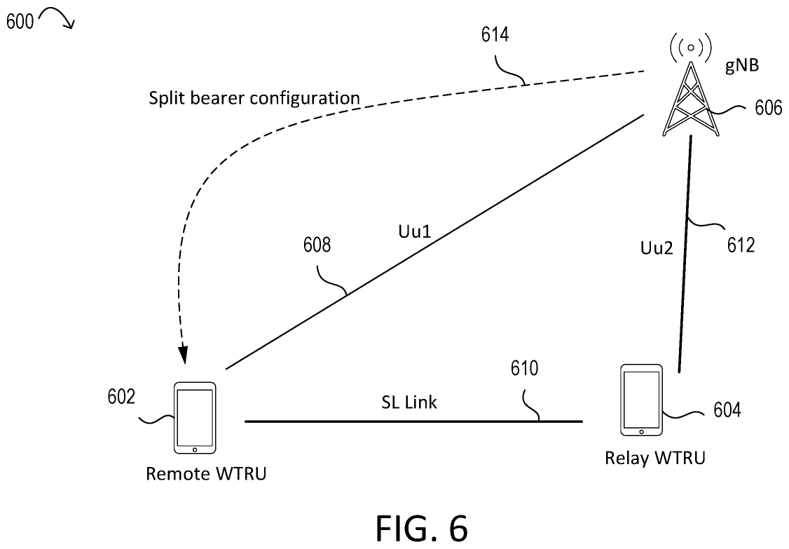

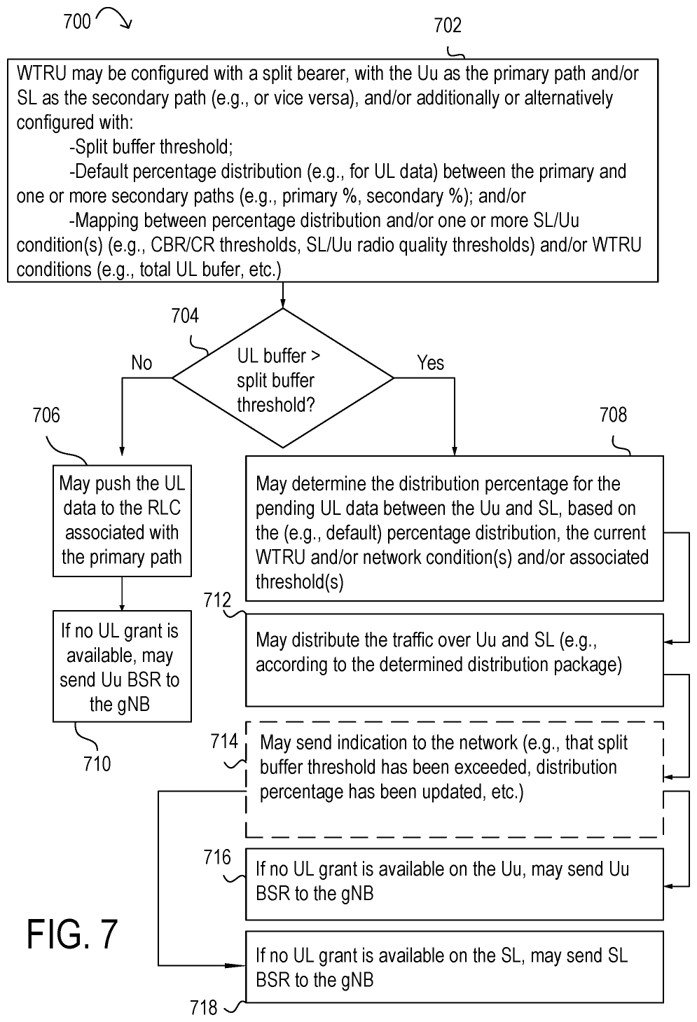

FIGS. 6 and 7 illustrate an example associated with the techniques discussed herein. As shown in FIGS. 6 and 7, a WTRU may be configured with a split bearer. For example, the WTRU may be configured with the split bearer in which the Uu is the primary path, and the SL is the secondary path. Also, or alternatively WTRU may be configured with the split bearer in which the Uu is the secondary path, and the SL is the primary path. The WTRU may be additionally configured with one or more of a split buffer threshold, a default percentage distribution between the primary and secondary paths, and a mapping between percentage distribution and SL/Uu conditions and WTRU conditions. As described herein, SL/Uu conditions may, for example, include CBR/CR thresholds, SL/Uu radio quality thresholds, and the like. As described herein, WTRU conditions may, for example, include a total UL buffer.

FIG. 7 illustrates an example flowchart 700 associated with split bearer configurations. At 702, a WTRU may be configured with a split bearer, where the Uu is the primary path and the SL is the secondary path (e.g., or the Uu as the secondary path and the SL as the primary path). Additionally, or alternatively, the WTRU may be configured with one or more of the following: a split buffer threshold; default percentage distribution (e.g., for UL data) between the primary and secondary paths (e.g., primary percentage, secondary percentage); and/or mapping between the percentage distribution and the one or more SL and/or Uu thresholds/conditions (e.g., CBR and/or CR threshold(s), SL and/or Uu radio quality threshold(s) and the one or more WTRU thresholds/conditions (e.g., total UL buffer, etc.).

At 704, the WTRU may determine whether the UL buffer is greater than the split buffer threshold. If the WTRU determines that the UL buffer is not greater than the split buffer threshold (e.g., at 704: NO), the WTRU may push (e.g., transmit) the UL data to the RLC associated with the primary path (e.g., at 706). If the WTRU determines that there is no available UL grant, the WTRU may send an Uu BSR to the gNB (e.g., at 710). If the WTRU determines that the UL buffer is greater than the split buffer threshold (e.g., 704: YES), the WTRU may determine the distribution percentage for the pending UL data between the Uu and SL (e.g., at 708). The WTRU may determine the distribution percentage for the pending UL data between the Uu and SL based on one or more of: the default percentage distribution; the one or more current WTRU and/or network thresholds/conditions (e.g., CBR/CR, SL/Uu radio quality, and the like); and/or one or more associated thresholds. At 712, the WTRU may distribute the traffic over Uu and/or SL according to the determined distribution percentage. At 714, the WTRU may send an indication to the network (e.g., to indicate that the split buffer threshold has been exceeded, that the percentage has been updated, etc.). At 716, if the WTRU determines that no UL grant is available on the Uu, the WTRU may send the Uu BSR to the gNB. At 718, if the WTRU determines that no UL grant is available on the SL, the WTRU may send SL BSR to the gNB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit receive unit (WTRU) comprising:
a processor configured to:
receive, from a network node, configuration information associated with uplink (UL) transmissions over a split bearer, wherein the split bearer is associated with a direct link with the network node and a sidelink (SL) with a relay;
determine a transmission distribution percentage associated with UL transmissions over the direct link and the SL based at least on the configuration information, channel conditions associated with the direct link, and channel conditions associated with the SL; and
send uplink data associated with the split bearer based on the determined transmission distribution percentage.

2. The WTRU of claim 1, wherein the configuration information comprises radio quality thresholds associated with channel conditions over the direct link and the SL.

3. The WTRU of claim 2, wherein the radio quality thresholds comprises a reference signal received power (RSRP) threshold.

4. The WTRU of claim 2, wherein the radio quality thresholds comprise a channel busy ratio (CBR) threshold.

5. The WTRU of claim 1, wherein the configuration information comprises an indication of a split buffer threshold associated with the split bearer, and wherein the transmission distribution percentage is further based on a buffer level of the WTRU.

6. The WTRU of claim 5, wherein the processor is further configured to update the split buffer threshold associated with the split bearer based on channel conditions associated with the direct link first path and channel conditions associated with the SL.

7. The WTRU of claim 6, wherein the channel conditions associated with the direct link comprise a current CBR associated with the direct link.

8. The WTRU of claim 6, wherein the channel conditions associated with the SL comprise a current radio quality associated with the SL.

9. The WTRU of claim 5, wherein the processor is further configured to send an indication of the updated split buffer threshold.

10. The WTRU of claim 1, wherein the processor is further configured to update the transmission distribution percentage associated with UL transmissions over the split bearer based on channel conditions associated with the direct link and channel conditions associated with the SL.

11. The WTRU of claim 7, wherein the processor is further configured to send an indication of the updated transmission distribution percentage.

12. A method performed by a wireless transmit receive unit (WTRU), the method comprising:
receiving, from a network node, configuration information associated with uplink (UL) transmissions over a split bearer, wherein the split bearer is associated with a direct link with the network node and a sidelink (SL) with a relay;
determining a transmission distribution percentage associated with UL transmissions over the direct link and the SL based at least on the configuration information, channel conditions associated with the direct link, and channel conditions associated with the SL; and
sending uplink data associated with the split bearer based on the determined transmission distribution percentage.

13. The method of claim 12, wherein the configuration information comprises radio quality thresholds associated with channel conditions over the direct link and the SL.

14. The method of claim 12, wherein the configuration information comprises an indication of a split buffer threshold associated with the split bearer, and wherein the transmission distribution percentage is further based on a buffer level of the WTRU.

15. The method of claim 14, the method further comprising updating the split buffer threshold associated with the split bearer based on channel conditions associated with the direct link and channel conditions associated with the SL.

16. The method of claim 15, wherein the channel conditions associated with the direct link comprise a current CBR associated with the direct link.

17. The method of claim 15, wherein the channel conditions associated with the SL comprise a current radio quality associated with the SL.

18. The method of claim 14, the method further comprising sending an indication of the updated split buffer threshold.

19. (canceled)

20. (canceled)

21. The method of claim 13, wherein the radio quality thresholds comprise a reference signal received power (RSRP) threshold.

22. The method of claim 13, wherein the radio quality thresholds comprise a channel busy ratio (CBR) threshold.
